(19) United States
(12) Patent Application Publication
(10) Pub. No.: US 2018/0192693 A1
(43) Pub. Date: Jul. 12, 2018

(54) FLAVORED HOOKAH MOUTHPIECE ACCESSORY

(71) Applicant: J'Leon Love, Las Vegas, NV (US)

(72) Inventor: J'Leon Love, Las Vegas, NV (US)

(21) Appl. No.: 15/402,205

(22) Filed: Jan. 9, 2017

(51) Int. Cl. A24F 1/30; A24F 7/00; A23G 3/34

(52) U.S. Cl. CPC A24F 1/30; A23V 2002/00; A23G 3/343; A24F 7/00

(57) ABSTRACT

A flavored hookah mouthpiece accessory for providing a flavor to a user smoking a hookah comprises a foil and a funnel shaped mouthpiece. The funnel shaped mouthpiece is configured to receive the folded foil in an inner surface of the funnel shaped mouthpiece. A lower section of the funnel shaped mouthpiece is dipped into one or more sugared candy mixtures. The lower section of the funnel shaped mouthpiece is operably connected to the hookah for providing the flavor to the user smoking the hookah.

### TECHNICAL FIELD OF THE INVENTION

The invention disclosed herein generally relates to hookah accessories. More particularly, the invention relates to a flavored hookah mouthpiece accessory.

### BACKGROUND

Smoking hookah have been a popular recreational activity for centuries. From the time of its possible origins in Persia or India, the hookah has gradually evolved to its modern day version of the flavored or tobacco-free hookahs. Hookah refers to an apparatus for vaporizing and smoking tobacco or tobacco-free gel. Various flavored hookahs have been devised over the years to add to the recreational value of the hookah. Typically, the flavored tobacco or tobacco-free gel is placed in a bowl. The ingredients placed in the hookah bowl are then lit with charcoal. The vapor produced is passed through a water basin before inhalation via a mouthpiece, generally housed in glass. Traditionally, the flavors are added into the bowl of the hookah. A single or a plurality of users must use the same flavor until the entire added flavor is used up completely. An accessory, which allows a single user or multiple users to smoke different flavors of the hookah simultaneously, is required. Furthermore, existing flavored hookah instruments have flavors that interfere with the normal flow of smoke or vapors through the mouthpiece. An accessory, which prevents the interference of the flavor with the normal flow of smoke or vapors, is required.

Hence, there is a long felt but unresolved need for an accessory, which prevents the interference of the flavor with the normal flow of smoke and vapors. Furthermore, there is a need for an accessory, which allows a single user or multiple users to smoke different flavors of the hookah simultaneously.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The flavored hookah mouthpiece accessory disclosed herein addresses the above-mentioned need for an accessory, which prevents the interference of the flavor with the normal flow of smoke and vapors. Furthermore, the invention addresses the need for an accessory, which allows a single user or multiple users to smoke different flavors of the hookah simultaneously. The flavored hookah mouthpiece accessory for providing a flavor to a user smoking a hookah comprises a foil and a funnel shaped mouthpiece. The funnel shaped mouthpiece is configured to receive the folded foil in an inner surface of the funnel shaped mouthpiece. A lower section of the funnel shaped mouthpiece is dipped into one or more sugared candy mixtures. The lower section of the funnel shaped mouthpiece is operably connected to the hookah for providing the flavor to the user smoking the hookah.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a top perspective view of a foil being inserted into a funnel shaped mouthpiece of a flavored hookah mouthpiece accessory.

FIG. 2 exemplarily illustrates a top perspective view of a foil inserted into a funnel shaped mouthpiece of a flavored hookah mouthpiece accessory.

FIG. 3 exemplarily illustrates a method for providing a flavor to a user smoking a hookah.

### DETAILED DESCRIPTION OF THE INVENTION

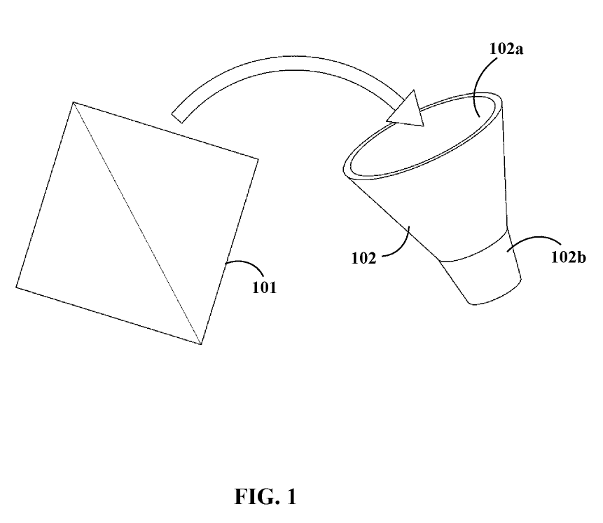

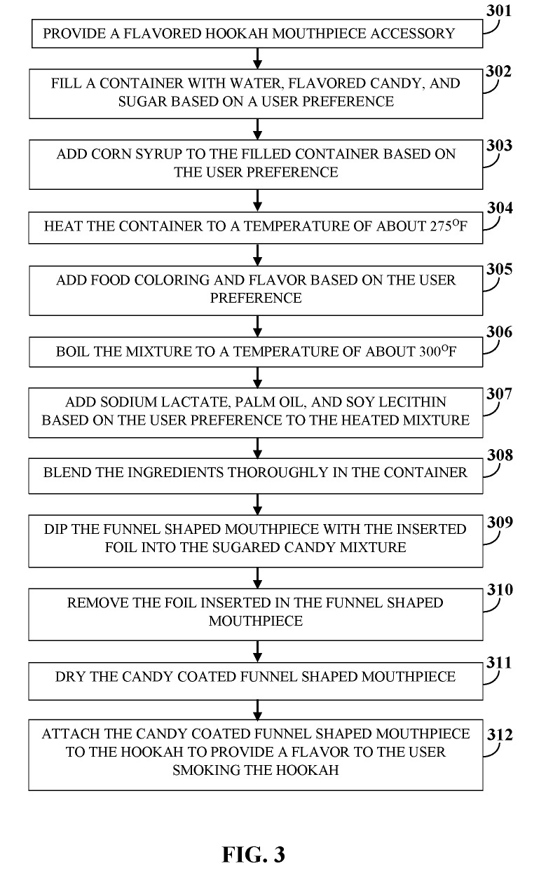

FIG. 1 exemplarily illustrates a top perspective view of a foil 101 being inserted into a funnel shaped mouthpiece 102 of a flavored hookah mouthpiece accessory 100. A flavored hookah mouthpiece accessory 100 for providing a flavor to a user smoking a hookah comprises a foil 101 and a funnel shaped mouthpiece 102. The funnel shaped mouthpiece 102 is configured to receive the folded foil 101 in an inner surface 102a of the funnel shaped mouthpiece 102. The lower section 102b of the funnel shaped mouthpiece 102 is dipped into one or more sugared candy mixtures. The lower section 102b of the funnel shaped mouthpiece 102 is operably connected to the hookah for providing the flavor to the user smoking the hookah. The flavored hookah mouthpiece accessory 100 prevents bad breath and keeps the mouth lubricated. In an embodiment, an assortment of the flavored hookah mouthpiece accessories 100 may be provided as a set with the flavored hookah mouthpiece accessories 100 dipped in one or more sugared candy mixtures as disclosed in the detailed description of FIG. 3. In an embodiment, the flavored hookah mouthpiece accessory 100 offers a variety of sweet sugary tastes without interfering with the normal flow of smoke and vapors through the funnel shaped mouthpiece 102.

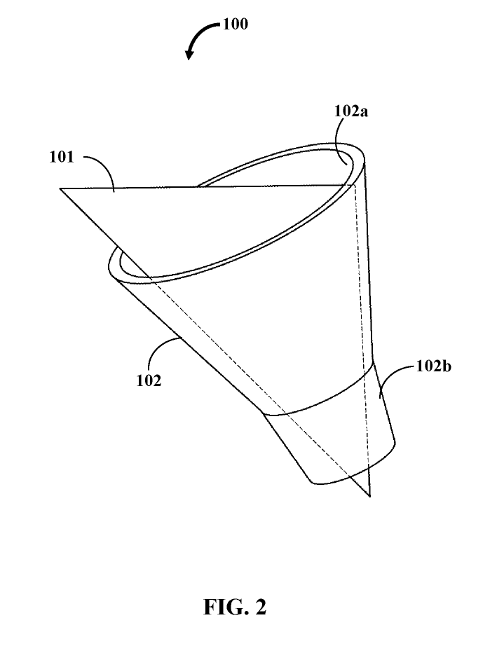

FIG. 2 exemplarily illustrates a top perspective view of a foil 101 inserted into a funnel shaped mouthpiece 102 of a flavored hookah mouthpiece accessory 100. In an embodiment, the foil 101 is made of an aluminum material. The foil 101 is a folded and positioned proximal to the inner surface 102a of the funnel shaped mouthpiece 102, as exemplarily illustrated in FIG. 2. A portion of the foil 101 extending from the lower section 102b of the funnel shaped mouthpiece 102 is cut using scissors. The lower section 102b of the funnel shaped mouthpiece 102 is dipped into one or more sugared candy mixtures prepared as disclosed in the detailed description of FIG. 3. In an embodiment, the funnel shaped mouthpiece 102 of the flavored hookah mouthpiece accessory 100 contains multiple flavors. Moreover, the flavor provided is long lasting taste and outlasts the hookah itself, thereby requiring minimal replacement. In another embodiment, the flavored hookah mouthpiece accessory 100 is configured in multiple shapes and dimensions to expand the variety of smoking instruments that the flavored hookah mouthpiece accessory equips to.

FIG. 3 exemplarily illustrates a method for providing a flavor to a user smoking a hookah. In the method disclosed herein, a flavored hookah mouthpiece accessory 100 comprising a foil 101 and a funnel shaped mouthpiece 102 is provided 301. A container is filled 302 with water, flavored candy, and sugar based on user preference. Corn syrup is added 303 to the filled container based on the user preference. The container is heated 304 to a temperature of about 275° F. Food coloring and flavor is added 305 based on the user preference. The mixture is boiled 306 to a temperature of about 300° F. The sodium lactate, palm oil, and soy lecithin is added 307 based on the user preference to the heated mixture. The added ingredients are blended 308 thoroughly in the container. The funnel shaped mouthpiece 102 is dipped 309 with the inserted foil 101 into the sugared candy mixture in the container. The foil 101 inserted in the funnel shaped mouthpiece 102 is removed 310. The candy coated funnel shaped mouthpiece 102 is dried 311. The candy coated funnel shaped mouthpiece 102 is attached 312 to the hookah to provide a flavor to the user smoking the hookah.

The foregoing examples have been provided merely for the purpose of explanation and are in no way to be construed as limiting of the flavored hookah mouthpiece accessory 100, disclosed herein. While the flavored hookah mouthpiece accessory 100 has been described with reference to various embodiments, it is understood that the words, which have been used herein, are words of description and illustration, rather than words of limitation. Further, although the flavored hookah mouthpiece accessory 100, has been described herein with reference to particular means, materials, and embodiments, the flavored hookah mouthpiece accessory 100 is not intended to be limited to the particulars disclosed herein; rather, the flavored hookah mouthpiece accessory 100 extends to all functionally equivalent structures, methods and uses, such as are within the scope of the appended claims. Those skilled in the art, having the benefit of the teachings of this specification, may effect numerous modifications thereto and changes may be made without departing from the scope and spirit of the flavored hookah mouthpiece accessory 100 disclosed herein in their aspects.

What is claimed is:

1. A flavored hookah mouthpiece accessory for providing a flavor to a user smoking a hookah, the flavored hookah mouthpiece accessory comprising:
a foil; and
a funnel shaped mouthpiece configured to receive the folded foil in an inner surface of the funnel shaped mouthpiece, a lower section of the funnel shaped mouthpiece dipped into one or more sugared candy mixtures, wherein the lower section of the funnel shaped mouthpiece is operably connected to the hookah for providing the flavor to the user smoking the hookah.

2. The flavored hookah mouthpiece accessory of claim 1, wherein the foil is an aluminum foil.

3. A method for providing a flavor to a user smoking a hookah, the method comprising:
providing a flavored hookah mouthpiece accessory comprising:
a foil; and
a funnel shaped mouthpiece;
filling a container with water, flavored candy, and sugar based on user preference;
adding corn syrup to the filled container based on the user preference;
heating the container to a temperature of about 275° F.;
adding food coloring and flavor based on the user preference;
boiling the mixture to a temperature of about 300° F.;
adding sodium lactate, palm oil, and soy lecithin based on the user preference to the heated mixture;
blending the ingredients thoroughly in the container;
dipping the funnel shaped mouthpiece with the inserted foil into the sugared candy mixture;
removing the foil inserted in the funnel shaped mouthpiece;
drying the candy coated funnel shaped mouthpiece; and
attaching the candy coated funnel shaped mouthpiece to the hookah to provide a flavor to the user smoking the hookah.

4. The method of claim 1, wherein the foil is an aluminum foil.
